(19) United States
(12) Patent Application Publication
(10) Pub. No.: US 2011/0085148 A1
(43) Pub. Date: Apr. 14, 2011

(54) LIGHT SOURCE DEVICE AND PROJECTOR

(75) Inventor: Susumu ARUGA, Shiojiri-shi (JP)

(73) Assignee: SEIKO EPSON CORPORATION, Tokyo (JP)

(21) Appl. No.: 12/862,280

(22) Filed: Aug. 24, 2010

(30) Foreign Application Priority Data
Oct. 8, 2009 (JP) 2009-234287

(51) Int. Cl. G03B 21/28; F21V 7/06; F21V 7/08; F21V 7/09

(52) U.S. Cl. 353/99; 362/298; 362/301

(57) ABSTRACT

A light source device includes: an arc tube; a first reflection mirror which surrounds a part of the entire circumference of the arc tube around an optical axis; and a second reflection mirror disposed oppositely to the first reflection mirror, wherein the curvature at the cross point of a fourth plane extending in parallel with a plane extending perpendicular to the optical axis and containing the light emission area and the cross-sectional shape on a third plane passing through the light emission area, extending in parallel with the optical axis, and crossing a first plane passing through a light emission area and extending in parallel with the optical axis in the first reflection mirror is larger than the curvature at the cross point of the fourth plane and the cross-sectional shape on the first plane in the first reflection mirror.

### BACKGROUND

1. Technical Field

The present invention relates to a light source device and a projector.

2. Related Art

A projector is known as an apparatus capable of displaying a large-screen image. An example of the projector includes an illumination system, an image forming device, and a projection lens. Illumination light emitted from the illumination system is formed into an image by the function of the image forming device. The image thus formed is expanded and projected through the projection lens, allowing a large-screen image to be more easily produced than in case of a direct-viewing-type image display device.

Recently, there is an increasing demand for a projector which is made compact so as to be used at an arbitrary place for display of expanded images. For realizing the miniaturization of the projector, various technologies for size reduction of components included in the projector have been developed. One of such technologies is directed to development of an illumination device which is compact but not considerably lowers the light emission amount. An example of this technology is disclosed in JP-A-2001-109068.

JP-A-2001-109068 proposes an illumination device having a main reflection mirror and a sub reflection mirror each of which has a half-split shape. According to this structure, a half-split reflection mirror divided along a plane parallel with an optical axis is employed in place of an ordinary full-surrounding type reflection mirror which has a reflection surface surrounding an arc tube so as to reduce the size of the reflection mirror and thus miniaturize the light source device. In addition, a small sub reflection mirror which reflects light not directly reaching the half-split reflection mirror (main reflection mirror) from the arc tube toward the main reflection mirror is provided so as to maintain the light emission amount while reducing the size of the illumination device.

According to an ordinary lamp (light source device) which includes an arc tube for emitting light and a reflection mirror surrounding the periphery of the arc tube to reflect the light emitted from the arc tube, it is known that a part of light reflected by the reflection mirror is blocked by the arc tube due to the physical shape of the arc tube. In this case, illumination efficiency lowers. The term “illumination efficiency” is herein defined as (light emission amount from lamp)/(total light emission amount from arc tube).

It is known that the illumination efficiency is affected by the relative sizes of the reflection mirror and the arc tube. More specifically, the illumination efficiency lowers as the size of the arc tube relative to the size of the reflection mirror (opening diameter of the reflection mirror) increases due to the enlarged shadow of the arc tube to block the reflection light. On the other hand, the illumination efficiency increases as the size of the arc tube relative to the size of the reflection mirror decreases.

It is known that the illumination efficiency stops rising after the increase in the illumination efficiency reaches a certain level. Thus, the size of the reflection mirror is designed such that the illumination efficiency becomes substantially the maximum based on the relationship between the sizes of the reflection mirror and the arc tube.

However, even when the half-split main reflection mirror is produced based on the shape of the reflection mirror determined under this principle, the expected illumination efficiency cannot be provided according to the findings of the present inventor.

### SUMMARY

It is an advantage of some aspects of the invention to provide a light source device capable of achieving both size reduction and high illumination efficiency. It is another advantage of some aspects of the invention to provide a projector including this light source device.

According to the investigations of the present inventor, a sub reflection mirror provided on a light source device produces a shadow to block reflection light and thus lowers illumination efficiency. More specifically, while the size of the main reflection mirror relative to the size of the arc tube is designed such that the light reflected by the main reflection mirror is not supplied to the arc cube under an ordinary design principle, the size of the main reflection mirror relative to the sub reflection mirror also needs to be determined such that the light reflected by the main reflection mirror is not supplied to the sub reflection mirror in the structure including the sub reflection mirror provided to cover the arc tube according to the findings of the inventor.

A light source device according to a first aspect of the invention includes: an arc tube; a first reflection mirror which surrounds a part of the entire circumference of the arc tube around an optical axis of the arc tube to reflect light emitted from the arc tube toward an illumination target; and a second reflection mirror disposed oppositely to the first reflection mirror with the optical axis of the arc tube interposed between the first and second reflection mirrors to reflect light emitted from the arc tube toward the first reflection mirror. The second reflection mirror is located in one of two spaces divided by a first plane passing through a light emission area within the arc tube and extending in parallel with the optical axis. A part of the first reflection mirror positioned on the side opposite to the illumination target with respect to a second plane extending perpendicular to the optical axis and containing the light emission area has a cross-sectional shape on a third plane which passes through the light emission area, extends in parallel with the optical axis, and crosses the first plane as a cross-sectional shape containing a part of an ellipse or a parabola. The curvature at the cross point of a fourth plane extending in parallel with the second plane and the cross-sectional shape on the third plane in a part of the first reflection mirror is larger than the curvature at the cross point of the fourth plane and the cross-sectional shape on the first plane in the part of the first reflection mirror.

The “optical axis of the arc tube” herein refers to an axis which passes through the light emission area within the arc tube and corresponds to a substantially symmetric axis in the light emission distribution of the arc tube. A part of light emitted from the arc tube is reflected by the first reflection mirror and released, and the remaining part of the light is reflected by the second reflection mirror, passes through the arc tube, and is reflected by the first reflection mirror to be released from the first reflection mirror together with the light having directly reached the first reflection mirror from the arc tube. In this case, the emission light amount does not considerably lower when the structure is designed such that the light emitted from the arc tube toward the second reflection mirror can be reflected by the second reflection mirror and returned to the first reflection mirror with high efficiency. In addition, each of the first reflection mirror and the second reflection mirror has a shape corresponding to a part of a concave surface reflection mirror in related art. Thus, the size of the device is considerably smaller than that of a device in related art.

Since the second reflection mirror is disposed in one of the two spaces divided by the first plane, the light emission area is not buried within the second reflection mirror. Thus, some light contained in the light emitted from the light emission area toward the one space where the second reflection mirror is provided reaches the first reflection mirror and is reflected thereon without reaching the second reflection mirror. In this case, there is a possibility that the second reflection mirror covering the arc tube becomes an obstacle for the light reflected by the first reflection mirror and lowers the illumination efficiency. According to this structure, however, the curvature of the cross-sectional shape of the first reflection mirror on the first plane is smaller than the curvature of the other area (the radius of curvature is larger). In this case, the reflection light is not easily supplied to the second reflection mirror by the enlarged reflection angle of the reflection light. Thus, lowering of the illumination efficiency can be reduced.

Accordingly, the light source device achieves both size reduction and high illumination efficiency.

It is preferable that the first reflection mirror has a shape having a flat portion of a spheroid or a paraboloid of revolution such that the cross-sectional shape on the second plane becomes a part of an ellipse, and that the major axis of a part of the ellipse of the cross-sectional shape on the second plane extends in parallel with the first plane.

According to this structure, the reflection surface of the first reflection mirror becomes a successive surface which regularly changes. In this case, the designing is facilitated, and thus the light source device capable of achieving both size reduction and high illumination efficiency can be easily produced.

It is preferable that each of the cross-sectional shape of the first reflection mirror on the first plane and the cross-sectional shape of the first reflection mirror on the third plane is a part of an ellipse, and that the light emission area agrees with each arc tube side focus of the ellipses of the cross-sectional shapes on the first plane and the third plane.

According to this structure, light emitted via the first reflection mirror can be converged on the focuses of the respective ellipses without diffusion. Thus, the efficiency of using light can be increased. Moreover, even in the structure which includes the first reflection mirror having the cross-sectional shapes on the first plane and the third plane as shapes each constituted by a part of a different ellipse, light emitted from the light source can be easily controlled when released from the same focus position as in this structure. Accordingly, the design of the optical systems disposed downstream can be facilitated.

It is preferable that substantially the entire circumference of the arc tube around the optical axis is surrounded by the first reflection mirror and the second reflection mirror.

According to this structure, light contained in the light emitted from the arc tube toward substantially the entire circumference and lost without reaching neither the first reflection mirror nor the second reflection mirror (light not emitted substantially in one direction along the light source optical axis) can be reduced. Thus, most part of the light emitted from the arc tube can be effectively used as light for illuminating the illumination target.

A projector according to a second aspect of the invention includes: the light source device described above; a light modulation element which modulates light emitted from the light source device; and a projection system which projects light modulated by the light modulation element.

According to this structure, the projector includes the light source device described above. Thus, the projector can achieve both size reduction of the device and high illumination efficiency sufficient for maintaining luminance of images.

It is preferable that the projector further includes an optical member on an optical path between the light source device and the light modulation element to cancel aberration of a reflection surface formed on the first reflection mirror.

The first reflection mirror of the light source device has the cross-sectional shape having different curvatures. In this case, the convergence position of the reflection light varies, thereby producing axial aberration. According to this structure, the aberration thus produced can be cancelled by the optical member provided on the optical path, and thus blur and fuzz on the formed images can be reduced. Accordingly, the projector can provide high-quality image display.

It is preferable that the optical member is a collimating lens which has aberration sufficient for canceling the aberration of the reflection surface of the first reflection mirror.

According to this structure, the collimating lens as the optical member provided in an ordinary projector has aberration sufficient for canceling the aberration of the first reflection mirror. Thus, the projector can provide high-quality image display without increasing the number of the components.

### BRIEF DESCRIPTION OF THE DRAWINGS

The invention will be described with reference to the accompanying drawings, wherein like numbers reference like elements.

FIG. 1 is a perspective view illustrating the general structure of a light source device according to an embodiment of the invention.

FIGS. 2A and 2B are cross-sectional views illustrating the general structure of the light source device according to the embodiment of the invention.

FIGS. 3A and 3B schematically illustrate the behavior of light emitted from an arc tube of the light source device.

FIGS. 4A and 4B schematically illustrate the behavior of light emitted from the arc tube of the light source device.

FIG. 5 schematically illustrates the general structure of a projector according to the embodiment of the invention.

FIG. 6 is a cross-sectional view schematically illustrating the general structure of an illumination system included in the projector.

FIG. 7 schematically illustrates a polarization converting element included in the projector.

### DESCRIPTION OF EXEMPLARY EMBODIMENT

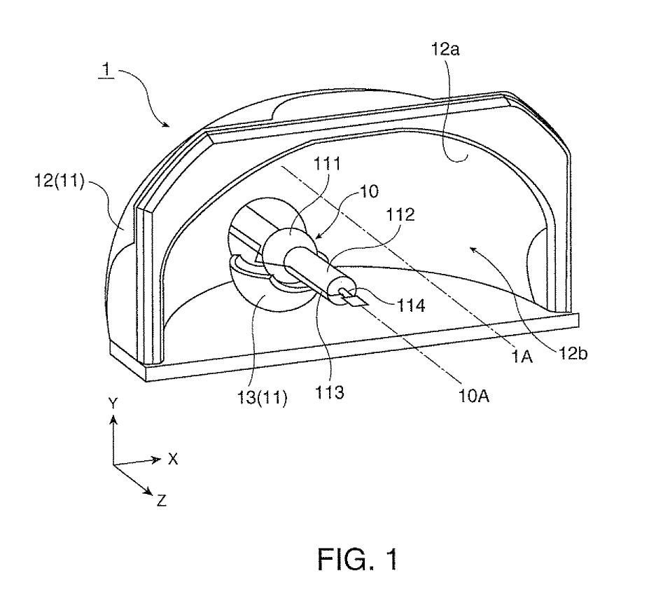

A light source device according to an embodiment of the invention is hereinafter described with reference to FIGS. 1 through 4B. The sizes and proportions of respective components shown in each of the figures are varied for easy understanding of the figures.

FIG. 1 is a perspective view illustrating the general structure of the light source device according to this embodiment. As can be seen from the figure, a light source device 1 includes an arc discharge type arc tube (hereinafter abbreviated as “arc tube” in some cases), and a reflector 11. The reflector 11 has a main reflector (first reflection mirror) 12, and a sub reflector (second reflection mirror) 13. Each of the main reflector 12 and the sub reflector 13 has a concave reflection surface disposed oppositely to the other.

The arc tube 10 is disposed in an area surrounded by the main reflector 12 and the sub reflector 13. The arc tube 10 extends substantially in the axial direction of a light source axis 10A (optical axis of arc tube; hereinafter referred to as lamp axis), and has a shape almost axially symmetric with respect to the lamp axis 10A. The optical axis of the light source device 1 extends in substantially parallel with the lamp axis 10A.

The positional relationship between the respective components is now explained based on an XYZ rectangular coordinate system shown in the figures. According to the XYZ rectangular coordinate system, the Z direction corresponds to the direction parallel with the optical axis of the light source device 1, i.e., the direction parallel with the lamp axis 10A, and the X direction and the Y direction correspond to directions perpendicular to each other within a plane crossing the optical axis at right angles. The sub reflector 13 is disposed in one of two spaces divided by a “first plane” passing through a light emission area within the arc tube 10 and extending in parallel with the lamp axis 10A. The in-plane direction of the first plane corresponds to the X direction, and the normal direction of the first plane corresponds to the Y direction. Thus, the reflection surface of the sub reflector 13 faces the reflection surface of the main reflector 12 in the Y direction.

A “second plane” according to the invention is a plane extending perpendicularly to the lamp axis 10A and containing the not-shown light emission area within the arc tube. A “third plane” is a plane passing through the light emission area, extending in parallel with the lamp axis 10A, and crossing the first plane. Similarly, a “fourth plane” is a plane extending in parallel with the second plane and shifted from the light emission area of the light source device 1 to the opposite side in the light emission direction.

The arc tube 10 includes a bulb portion 111, sealing portions 112, power supply terminals 113, and leads 114. The bulb portion 111 is a hollow and substantially spherical tube having an internal space. The bar-shaped sealing portions 112 are formed integrally with both ends of the bulb portion 111. The bulb portion 111 and the sealing portions 112 are made of transparent material having high heat resistance such as quartz glass and sapphire.

Each of the bar-shaped power supply terminals 113 is embedded in the corresponding sealing portion 112 in such a manner as to penetrate through the inside of the sealing portion 112, and the ends of the power supply terminals 113 are provided as a pair of electrodes opposed to each other in the internal space of the bulb portion 111. Light emission substances and gas are sealed into the internal space of the bulb portion 111. The light emission substances are constituted by mercury, metal halide or the like. The gas is constituted by rare gas, halogen gas or the like. In this embodiment, the arc tube 10 is fixed to the main reflector 12 in such a position that the extending direction of the power supply terminals 113 agrees with the lamp axis 10A.

The leads 114 are connected with the power supply terminals 113 directly or via not-shown caps such that power can be supplied to the power supply terminals 113 via the leads 114.

The arc discharge type arc tube 10 having this structure is constituted by a high-pressure mercury lamp, a metal halide lamp, a xenon lamp or the like.

The reflector 11 includes a base material having high heat resistance and large mechanical strength such as glass and crystallized glass, and a reflection mirror made of dielectric multilayer film, metal film or the like and formed throughout the area of the inner surface (the surface on the side that an arc tube is disposed) of the base material.

The main reflector 12 reflects light emitted from the arc tube 10 such that the light can travel substantially in the axial direction of the optical axis 1A toward the illumination target. The inner surface of the main reflector 12 opposed to the arc tube 10 corresponds to a reflection surface 12a having a reflection mirror. The illumination target side of the main reflector 12 corresponds to an opening 12b. The main reflector 12 has a flat shape constituted by a partially flat spheroid and the opening 12b expanded in the X axis direction. That is, the main reflector 12 is expanded both to the +X side and −X side in the X axis direction on the basis of the size in the Y axis direction.

Concerning the “elliptic” shape, the invention is applicable to a structure which has fine processing on the surface of the first reflection mirror and draws elliptic or parabolic envelopes. This applies to a structure including a “parabolic” reflection mirror as will be described later.

The sub reflector 13 has a function of reflecting light emitted from the arc tube 10 toward the main reflector 12, and includes a reflection mirror having a spherically concaved reflection surface. The main reflector 12 and the sub reflector 13 surround substantially the entire circumference of the arc tube 10 around the lamp axis 10A.

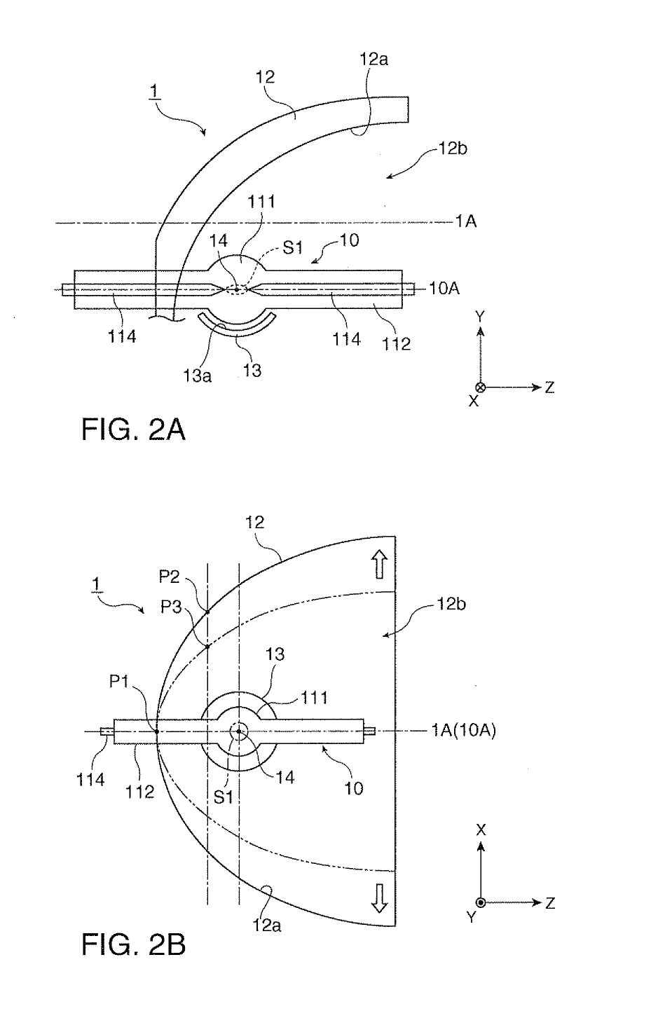

FIGS. 2A and 2B are cross-sectional views illustrating the general structure of the light source device 1. FIG. 2A schematically shows the cross-sectional structure of the light source device 1 on the plane (the third plane) containing the lamp axis 10A and extending in parallel with the Y-Z plane. FIG. 2B schematically shows the cross-sectional structure of the light source device 1 on the plane (the first plane) extending in parallel with the X-Z plane.

As illustrated in FIG. 2A, the pair of the power supply terminals 113 included in the arc tube 10 are formed by tungsten, for example. The power supply terminals 113 extend in the direction parallel with the lamp axis 10A (Z direction), and disposed away from each other by a predetermined space in the Z direction. The power supply terminals 113 are electrically connected with a power source via not-shown wires.

When voltage is applied between the power supply terminals 113, arc discharge is generated between the power supply terminals 113. The discharge gas within the arc tube 14 collides with electrons generated by the arc discharge and receives energy. As a result, a part of the discharge gas is excited or ionized. When the discharge gas brought into the exited condition returns to the ground condition or the metastable condition, the discharge gas emits light corresponding to the energy difference between the excited condition and the returned condition. The ionized discharge gas (plasma) reconnects with electrons and emits light corresponding to the binding energy. Consequently, light expanding almost radially is generated between the power supply terminals 113 to form a light emission spot (light emission area) S1 as an area having a certain degree of expansion between the power supply terminals 113. The arc tube 10 can be considered as a point light source having a light emission point 14 at the center of gravity of the luminance produced by the light emission spot S1.

The main reflector 12 and the sub reflector 13 are provided with the light emission point 14 interposed therebetween. Each of the cross-sectional shape of the main reflector 12 on the third plane containing the lamp axis 10A and extending in parallel with the Y-Z plane and the cross-sectional shape of the main reflector 12 on the first plane extending in parallel with the X-Z plane constitutes a part of an ellipse. The light emission point 14 is disposed at the position corresponding to the focus of these ellipses.

A reflection surface 13a of the sub reflector 13 contains a part of a spherical surface. The focus position corresponding to the center of the spherical surface almost agrees with the light emission point 14. The sub reflector 13 is disposed such that the reflection surface 13a is concaved toward the reflection surface 12a of the main reflector 12.

As illustrated in FIG. 2B, the cross-sectional shape of the main reflector 12 on the first plane extending in parallel with the X-Z plane constitutes a part of an ellipse as well. The part of the ellipse indicated by an alternate long and two short dashes line in the figure is the same part of the ellipse of the cross-sectional shape on the Y-Z plane described above. In FIG. 2B, this cross-sectional shape on the first plane parallel with the X-Z plane is compared with the cross-sectional shape on the third plane parallel with the Y-Z plane shown in FIG. 2A. However, for simplifying the explanation, the ellipse of the cross-sectional shape on the first plane as indicated by a solid line is herein compared with the ellipse indicated by the alternate long and two dashes line in the figure.

The main reflector 12 has the opening 12b expanded to the +X and −X sides in the X axis direction. Thus, comparing a cross point (point P2) of the plane (the fourth plane) perpendicular to the lamp axis 10A and a part of the ellipse as the cross-sectional shape on the first plane with a cross point (point P3) of the fourth plane and a part of the ellipse as the cross-sectional shape on the third plane in the partial area of the main reflector 12 shifted toward the root of the arc tube 10 (toward point P1) from the light emission spot S1, the curvature at the point P3 is larger than the curvature at the point P2.

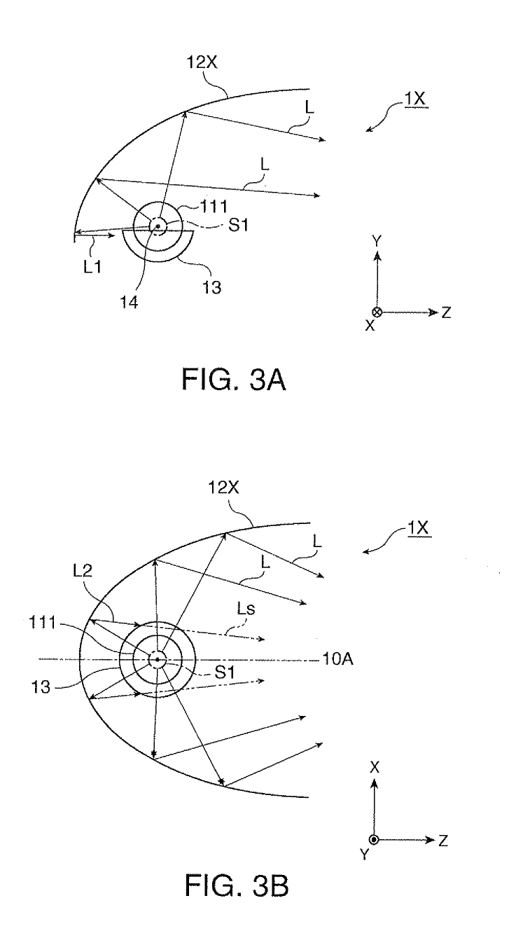

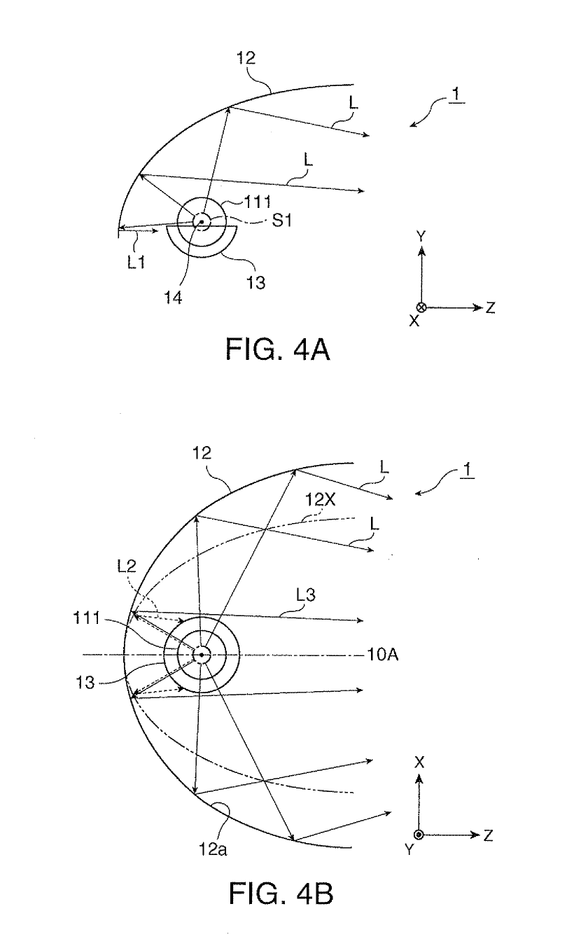

FIGS. 3A and 3B and FIGS. 4A and 4B schematically illustrate the concept of the behavior of the light emitted from the arc tube 10. FIGS. 3A and 3B show a light source device 1X which has a main reflector 12X having a related-art reflector shape constituted by a part of a spheroid. FIGS. 4A and 4B show the light source device 1 according to this embodiment. FIGS. 3A and 4A correspond to FIG. 2A, and FIGS. 3B and 4B correspond to FIG. 2C.

Since the center of the spherical surface constituting the reflection surface 13a of the sub reflector 13 almost agrees with the light emission point 14, the light emitted from the arc tube 10 toward the sub reflector 13 is reflected by the sub reflector 13 toward the light emission point. The behavior of the light after this reflection is the same as the behavior of the light directly emitted from the arc tube toward the main reflector 12. Thus, the behavior of the light emitted from the arc tube 10 toward the main reflector 12 both directly and indirectly is herein discussed.

In case of the light source device 1X which includes the main reflector 12X having the related-art reflector shape, light L emitted from the arc tube 10 toward the main reflector 12X and reaching the reflection surface 12a is reflected by the reflection surface 12a and converged on a second focus of the spheroid constituting a reflection surface 12y. However, a part of light L1 contained in the light emitted toward the main reflector 12X and traveling in the opposite direction (−Z direction) of the light emission direction of the light source device and in the direction not reaching the sub reflector 13 but coming close to the sub reflector 13 (−Y direction) is reflected by the main reflector 12X and released to the outside of the sub reflector 13.

Observing this phenomenon on the first plane, light L2 as a part of light emitted in the −Y direction and −Z direction is reflected by the main reflector 12X and supplied to the sub reflector 13. Thus, the illumination efficiency lowers by the amount of light Ls which may be supplied from the light source device 1X and used when the sub reflector 13 is not provided.

According to a typical light source device having a reflector and an arc tube, a part of light reflected by the reflector is inevitably blocked by the arc tube. Thus, the illumination efficiency lowers. It is known that the illumination efficiency is affected by the relative sizes of the reflector and the arc tube. More specifically, the arc tube more easily produces a shadow to block the light reflected by the reflector as the size of the arc tube (particularly the bulb portion) increases relative to the reflector (the opening diameter of the reflector). In this case, the illumination efficiency decreases. On the other hand, the illumination efficiency increases as the size of the arc tube decreases relative to the reflector.

This increase in the illumination efficiency stops after reaching a certain level. Thus, the size of the reflector is generally determined such that the illumination efficiency becomes the maximum based on the relationship between the sizes of the reflector and the arc tube.

In case of the light source device 1X shown in FIGS. 3A and 3B, the size of the main reflector 12X in the Y axis direction is determined such that the illumination efficiency becomes the maximum considering the relationship between the sizes of the arc tube 10 (the bulb portion 111) and the reflector 12X. However, since the reflection light is easily blocked by the amount corresponding to the size of the sub reflector 13 in the X axis direction, the light L2 is blocked by the sub reflector 13.

According to the light source device 1 in this embodiment illustrated in FIGS. 4A and 4B, the behavior of light on the third plane is similar to that in case of the light source device 1X shown in FIG. 4A. However, the behavior of light on the first plane shown in FIG. 4B is different from that in case of the light source device 1X.

As illustrated in FIG. 4B, the main reflector 12 is expanded in the X axis direction more than the main reflector 12X of the light source device 1X indicated by a broken line in the figure, and the curvature of the reflection surface 12a of the main reflector 12 to which the light L2 is supplied is smaller. The curvature of the main reflector 12 can be determined such that the illumination efficiency becomes substantially the maximum considering the relationship between the sizes of the sub reflector 13 and the arc tube based on the principle similar to that of the ordinary reflector.

According to the main reflector 12 having this structure, the light L2 which reaches the sub reflector 13 after reflected by the main reflector 12X in case of the light source device 1X does not reach the sub reflector 13 by the expanded reflection angle on the reflection surface 12a, and thus is released in the emission direction as light L3 and extracted to the outside of the light source device 1. As a result, the illumination efficiency becomes higher than that of the light source device 1X shown in FIGS. 3A and 3B.

The light source device 1 in this embodiment is constructed as above.

The light source device 1 having this structure can achieve both compactness and high illumination efficiency.

While the main reflector 12 in this embodiment has the cross-sectional shape constituted by a part of an ellipse, the shape may be a part of a parabola.

Similarly, while the main reflector 12 in this embodiment has a shape constituted by a flat part of a spheroid, the shape may be a flat part of a paraboloid of revolution.

In addition, while the reflection surface 12a of the main reflector 12 in this embodiment is a continuous surface, the main reflector may be formed by a collection of plural components and have a discontinuous reflection surface.

### Projector

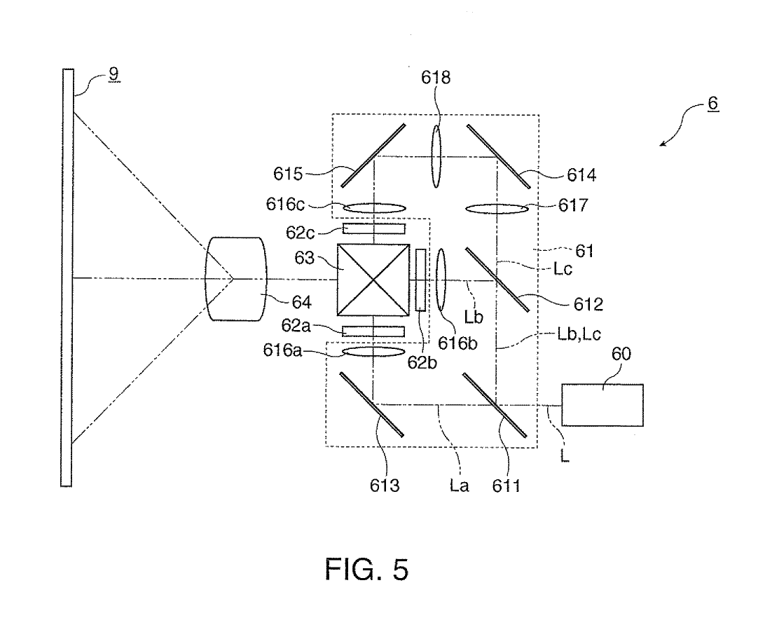

FIG. 5 schematically illustrates the general structure of a projector 6 according to the embodiment of the invention. As illustrated in the figure, the projector 6 includes an illumination system 60, a color separation system 61, liquid crystal light valves (light modulation elements) 62a through 62c, a color combining element 63, a projection system 64.

The projector 6 generally operates in the following manner. Light emitted from the illumination system 60 is separated into a plurality of color lights by the function of the color separation system 61. The plural color lights separated by the color separation system 61 are supplied to the corresponding liquid crystal light valves 62a through 62c for modulation. The plural color lights modulated by the liquid crystal light valves 62a through 62c are supplied to the color combining element 63 to be combined. The light combined by the color combining element 63 is expanded and projected on a projection receiving surface 9 such as a wall and a screen by the projection system 64 to be displayed as a full-color projection image. The respective constituent elements included in the projector 6 are now explained.

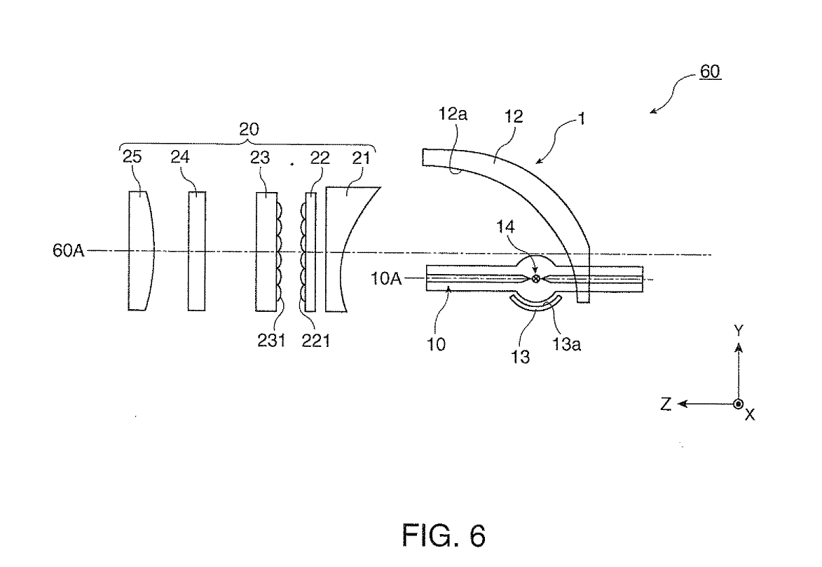

FIG. 6 is a cross-sectional view schematically illustrating the general structure of the illumination system 60. As can be seen from the figure, the illumination system 60 includes the light source device 1 according to the embodiment of the invention and an illumination optical system 20. The constituent elements of the illumination optical system 20 are arranged along an optical axis 60A of the illumination system 60. The optical axis 60A almost agrees with the optical axis of the light source device 1. The illumination optical system 20 includes a collimating lens 21, lens arrays 22 and 23, a polarization converting element 24, and a stacking lens 25 disposed in this order from the light source device 1 to the downstream side in the direction of the optical axis 60A.

The collimating lens 21 includes a concave lens to collimate light emitted from the light source device 1. Since the light source device 1 according to the embodiment of the invention has the main reflector 12 widened in the X axis direction, the light intensity distribution of the emitted light is wide and expanded in the X axis direction. For correcting the flatness of the light intensity distribution and reducing distortion of the light intensity distribution on the X-Y plane, it is preferable that the collimating lens 21 has aberration which widens the light intensity distribution of transmission light in the Y axis direction.

The lens arrays 22 and 23 equalize the luminance distribution of light received from the collimating lens 21. The lens array 22 contains a plurality of lenses 221, and the lens array 23 contains a plurality of lenses 231. The lenses 221 and the lenses 231 are disposed with one-to-one correspondence. The light released from the collimating lens 21 is spatially divided and supplied to the plural lenses 221. The lenses 221 form images of the received lights on the corresponding lenses 231. As a result, a secondary light source image is formed on each of the plural lenses 231.

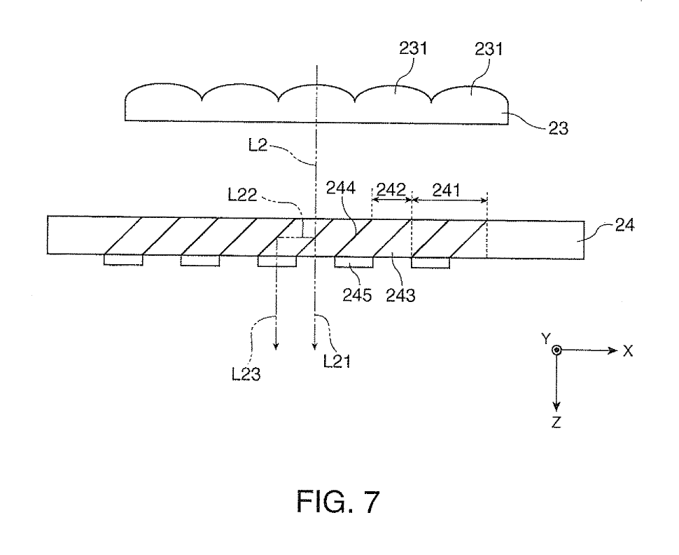

The polarization converting element 24 equalizes the polarization conditions of the lights L2 (see FIG. 7) received from the lens arrays 22 and 23. The polarization converting element 24 contains a plurality of polarization converting cells 241. The polarization converting cells 241 and the lenses 231 are disposed with one-to-one correspondence. The lights L2 from the secondary light source images formed on the lenses 231 enter entrance areas 242 of the polarization converting cells 241 corresponding to the lenses 231.

Each of the polarization converting cells 241 has a polarization beam splitter film 243 (hereinafter abbreviated as PBS film 243) and a retardation film 245 at positions corresponding to the entrance area 242. The light L2 having entered the entrance area 242 is divided into P-polarized light L21 and S-polarized light L22 with respect to the PBS film 243 by the function of the PBS film 243. Either the P-polarized light L21 or the S-polarized light L22 (S-polarized light L22 in this embodiment) is reflected by a reflection member 244 and supplied to the retardation film 245. The polarization condition of the light L22 having entered the retardation film 245 is converted into the polarization condition of the other polarized light (P-polarized light L21 in this embodiment) by the retardation film 245. As a result, P-polarized light L23 is produced and released together with the P-polarized light L21.

The stacking lens 25 stacks lights received from the polarization converting element 24 on the illumination receiving area. The light emitted from the light source device 1 is spatially divided and stacked so as to equalize the luminance distribution and increase axial symmetry around the optical axis 60A.

The color separation system 61 includes dichroic mirrors 611 and 612, mirrors 613 through 615, field lenses 616a through 616c, and relay lenses 617 and 618. Each of the dichroic mirrors 611 and 612 is produced by laminating dielectric multilayer films on a glass surface, for example. The dichroic mirrors 611 and 612 have characteristics of selectively reflecting color light having a predetermined wavelength range and transmitting color light having the other wavelength range. In this embodiment, the dichroic mirror 611 reflects green light and blue light, and the dichroic mirror 612 reflects green light.

The light L emitted from the illumination system enters the dichroic mirror 611. Red light La contained in the light L passes through the dichroic mirror 611 and reaches the mirror 613, where the red light La is reflected and supplied to the field lens 616a. Subsequently, the red light La is collimated by the field lens 616a and enters the liquid crystal light valve 62a.

Green light Lb and blue light Lc contained in the light L are reflected by the dichroic mirror 611 and supplied to the dichroic mirror 612. The green light Lb is reflected by the dichroic mirror 612 and reaches the field lens 616b. Subsequently, the green light Lb is collimated by the field lens 616b and supplied to the liquid crystal light valve 62b.

The blue light Lc transmitted by the dichroic mirror 612 passes through the relay lens 617, and is reflected by the mirror 614. Then, the blue light Lc having passed through the relay lens 618 is reflected by the mirror 615 and supplied to the field lens 616c. Subsequently, the blue light Lc is collimated by the field lens 616c and reaches the liquid crystal light valve 62c.

Each of the liquid crystal light valves 62a through 62c is constituted by a light modulation device such as a transmission type liquid crystal light valve. The liquid crystal light valves 62a through 62c are electrically connected with a signal source (not shown) such as a personal computer which supplies image signals containing image information. The liquid crystal light valves 62a through 62c modulate entering light by pixel and form images according to the supplied image signals. The liquid crystal light valves 62a through 62c form red images, green images, and blue images, respectively. Light (image) modulated (formed) by the liquid crystal light valves 62a through 62c enter the color combining element 63.

The color combining element 63 is constituted by a dichroic prism or the like. The dichroic prism has structure containing four triangle prisms affixed to each other. The surfaces of the triangle prisms affixed to each other constitute the inner surfaces of the dichroic prism. A mirror surface for reflecting red light and transmitting green light, and a mirror surface for reflecting blue light and transmitting green light are provided on the inner surfaces of the dichroic prism such that these mirrors cross each other at right angles. Green light having entered the dichroic prism passes through the mirror surfaces and is released without change. Red light and blue light having entered the dichroic prism are selectively reflected or transmitted by the mirror surfaces and released in the same direction as the emission direction of the green light. By this method, the three color lights (images) are stacked and combined to form combined color light, and the combined light thus formed is expanded and projected on the projection receiving surface 9 by the projection system 64.

The projector 6 having this structure includes the light source device 1 in this embodiment. Thus, the projector 6 can achieve both size reduction and high illumination efficiency sufficient for maintaining luminance of images.

According to this embodiment, the aberration of the main reflector 12 included in the light source device 1 is cancelled by the collimating lens 21. However, an optical member exclusively used for canceling the aberration may be provided on the optical path. Alternatively, even a structure which does not cancel the aberration of the main reflector 12 can achieve both size reduction of the projector and high illumination efficiency sufficient for maintaining luminance of images.

While the three-plate-type projector 6 has been discussed in this embodiment, the invention is applicable to a single-plate-type projector. The light modulation element may be a reflection-type liquid crystal light valve or a digital mirror device, for example. In this case, depending on the types of image forming devices the optical systems disposed on the optical path between the light source device and the image forming device, the optical systems disposed on the optical path between the image forming device and the projection system, the projection system and the like are changed as necessary.

Obviously, the invention is not limited to the preferred embodiment described with reference to the appended drawings. The shapes, combinations and the like of the respective components described herein are only examples and thus may be changed or modified according to design requirements or the like without departing from the scope of the invention.

The entire disclosure of Japanese Patent Application No. 2009-234287, filed Oct. 8, 2009 is expressly incorporated by reference herein.

What is claimed is:

1. A light source device comprising:
an arc tube;
a first reflection mirror which surrounds a part of the entire circumference of the arc tube around an optical axis of the arc tube to reflect light emitted from the arc tube toward an illumination target; and
a second reflection mirror disposed oppositely to the first reflection mirror with the optical axis of the arc tube interposed between the first and second reflection mirrors to reflect light emitted from the arc tube toward the first reflection mirror,
wherein
the second reflection mirror is located in one of two spaces divided by a first plane passing through a light emission area within the arc tube and extending in parallel with the optical axis,
a part of the first reflection mirror positioned on the side opposite to the illumination target with respect to a second plane extending perpendicular to the optical axis and containing the light emission area has a cross-sectional shape on a third plane which passes through the light emission area, extends in parallel with the optical axis, and crosses the first plane as a cross-sectional shape containing a part of an ellipse or a parabola, and
the curvature at the cross point of a fourth plane extending in parallel with the second plane and the cross-sectional shape on the third plane in a part of the first reflection mirror is larger than the curvature at the cross point of the fourth plane and the cross-sectional shape on the first plane in the part of the first reflection mirror.

2. The light source device according to claim 1, wherein
the first reflection mirror has a shape having a flat portion of a part of a spheroid or a part of a paraboloid of revolution such that the cross-sectional shape on the second plane becomes a part of an ellipse; and
the major axis of a part of the ellipse of the cross-sectional shape on the second plane extends in parallel with the first plane.

3. The light source device according to claim 1, wherein
each of the cross-sectional shape of the first reflection mirror on the first plane and the cross-sectional shape of the first reflection mirror on the third plane is a part of an ellipse; and
the light emission area agrees with each arc-tube side focus of the ellipses of the cross-sectional shapes on the first plane and the third plane.

4. The light source device according to claim 1, wherein substantially the entire circumference of the arc tube around the optical axis is surrounded by the first reflection mirror and the second reflection mirror.

5. A projector comprising:
the light source device according to claim 1;
a light modulation element which modulates light emitted from the light source device; and
a projection system which projects light modulated by the light modulation element.

6. The projector according to claim 5, further comprising an optical member on an optical path between the light source device and the light modulation element to cancel aberration of a reflection surface formed on the first reflection mirror.

7. The projector according to claim 6, wherein the optical member is a collimating lens which has aberration sufficient for canceling the aberration of the reflection surface of the first reflection mirror.
